(19) United States
(12) Patent Application Publication
(10) Pub. No.: US 2024/0033154 A1
(43) Pub. Date: Feb. 1, 2024

(54) MASSAGE APPARATUS AND METHOD OF CONTROLLING THE SAME

(71) Applicant: SAMSUNG ELECTRONICS CO., LTD., Suwon-si (KR)

(72) Inventors: Sunggyun PARK, Suwon-si (KR); Daesung KI, Suwon-si (KR); Chanyoung PARK, Suwon-si (KR); Jiho JEONG, Suwon-si (KR); Taeseob LIM, Suwon-si (KR)

(73) Assignee: SAMSUNG ELECTRONICS CO., LTD., Suwon-si (KR)

(21) Appl. No.: 18/203,224

(22) Filed: May 30, 2023

Related U.S. Application Data
(63) Continuation of application No. PCT/KR2023/004999, filed on Apr. 13, 2023.

(30) Foreign Application Priority Data
Jul. 29, 2022 (KR) 10-2022-0094907
Oct. 6, 2022 (KR) 10-2022-0128167

(51) Int. Cl. A61G 15/02; A61H 7/00; A61G 15/00

(52) U.S. Cl. CPC A61G 15/02; A61H 7/004; A61G 15/007; A61H 2201/0149; A61H 2201/0196; A61H 2201/5058; A61H 2201/1623; A61H 2203/0425; A61H 2205/081

(57) ABSTRACT

A massage apparatus includes a base frame; a first seat frame connected to the base frame to be rotatable with respect to the base frame, and including a seat portion on which a user is to be seated; a second seat frame coupled to the first seat frame to be rotatable with respect to the first seat frame, and including a backrest portion; a first driving unit connected to the base frame and the first seat frame to drive the first seat frame to rotate with respect to the base frame; a massage module accommodated in the second seat frame to perform a massage function; and a control unit configured to, upon an execution command for a massage course being input, control the first driving unit to rotate the first seat frame such that a rear side of the first seat frame is raised thereby raising the seat portion.

### CROSS REFERENCE TO THE RELATED APPLICATION

This application is a continuation application, filed under 35 U.S.C. § 111(a), of International Application PCT/KR2023/004999 filed on Apr. 13, 2023, and is based on and claims priority under 35 U.S.C. § 119 to Korean Patent Applications No. 10-2022-0094907, filed on Jul. 29, 2022, No. 10-2022-0128167, filed on Oct. 6, 2022, in the Korean Intellectual Property Office. The disclosures of which are incorporated by reference herein in their entireties.

### BACKGROUND

### Field

The present disclosure relates to a massage apparatus having an improved structure to assist a user with entering and exiting a seat.

### Description of the Related Art

A massage apparatus is an apparatus that allows a user to receive a massage while being seated, and provides a massage over all areas of the user's body.

A massage apparatus may be typically provided as a chair-type structure massage apparatus or a bed-type structure massage apparatus.

Inside a massage apparatus, a massage module for providing a user with a massage may be disposed. The massage module performs a massage by applying an appropriate shock to the user's body through rotation and reciprocation motions.

In the massage apparatus, a surface on which the user's body is seated may be covered with a soft material. In particular, a seat frame on which the user's buttocks are seated may be disposed inwards than an armrest frame provided on the side portions of the seat frame in the massage apparatus, providing a sense of comfort to the user.

However, in this case, when the user desires to sit down on the massage apparatus for a massage or desires to rise out of the massage apparatus after the end of the massage, there may be inconvenience in sitting or existing.

### SUMMARY

According to an aspect, there is provided a massage apparatus including: a base frame; a first seat frame connected to the base frame to be rotatable with respect to the base frame, the first seat frame including a seat portion on which a user is to be seated; a second seat frame coupled to the first seat frame so as to be rotatable with respect to the first seat frame, the second seat frame including a backrest portion on which the user's back is to be rested; a first driving unit connected to the base frame and the first seat frame to drive the first seat frame to rotate with respect to the base frame; a massage module accommodated in the second seat frame to perform a massage function; and a control unit configured to, upon an execution command for a massage course being input, control the first driving unit to rotate the first seat frame such that a rear side of the first seat frame is raised thereby raising the seat portion.

The massage apparatus may further include a second driving unit connected to the first seat frame and the second seat frame to drive the second seat frame to rotate with respect to the first seat frame so that the second seat frame may maintain a reference angle with respect to a ground according to a rotation of the first seat frame.

The massage apparatus may further include a sensor configured to detect a user, wherein the control unit may be configured to, upon determining the user as being seated on the massage apparatus based on a detection by the sensor, control the first driving unit to rotate the first seat frame so that the rear side of the first seat frame may be lowered.

The control unit may be configured to, after controlling to lower the rear side of the first seat frame, control the massage module to perform the massage function.

The control unit may be configured to, upon receiving a command to end the massage course, controlling the first driving unit to rotate the first seat frame such that the rear side of the first seat frame may be raised.

The control unit may be configured to control the second driving unit to drive the second seat frame so that the second seat frame may maintain the reference angle with respect to the ground according to the rotation of the first seat frame.

The control unit may be configured to, upon determining that the user may have departed from the massage apparatus based on a detection by the sensor, control the first driving unit to rotate the first seat frame such that the rear side of the first seat frame may be lowered.

The first seat frame may further include a frame support shaft extending sideward of the first seat frame and passing through the base frame such that the first seat frame may be coupled to be rotatable with respect to the base frame, wherein the first driving unit may include a base connection portion mounted on the base frame; and a seat connection portion connected to a lower surface of the first seat frame such that the first seat frame may rotate with respect to the base frame around the frame support shaft, the seat connection portion slidably movable with respect to the base connection portion.

According to an aspect, there is provided a method of controlling a massage apparatus, the method including: receiving an execution command for a massage course; and controlling to rotate a first seat frame, which is connected to a base frame so as to be rotatable with respect to the base frame so that a rear side of the first seat frame is raised thereby raising a seat portion included in the first frame.

The method may further include controlling to rotate a second seat frame, which may be coupled to the first seat frame so as to be rotatable with respect to the first seat frame to maintain a reference angle with respect to a ground according to the rotation of the first seat frame.

The method may further include detecting a user by a sensor; and upon determining that the user is seated on the massage apparatus based on a result of the detection by the sensor, controlling to rotate the first seat frame such that the rear side of the first seat frame is lowered.

The method may further include controlling a massage module to perform a massage function after lowering of the rear side of the first seat frame.

The method may further include: receiving a command to end the massage course; and controlling to rotate the first seat frame such that the rear side of the first seat frame is raised.

The method may further include controlling to rotate the second seat frame to maintain the reference angle with respect to the ground according to the rotation of the first seat frame.

The method may further include, upon determining that the user may have departed from the massage apparatus based on a detection of the user by the sensor, controlling to rotate the first seat frame such that the rear side of the first seat frame may be lowered.

The massage apparatus further comprises a second driving unit connected to the first seat frame and the second seat frame to drive the second seat frame to rotate with respect to the first seat frame so that the second seat frame is raised together with the first seat frame thereby raising the seat portion and the backrest portion together.

### BRIEF DESCRIPTION OF THE DRAWINGS

FIG. 1 is a perspective view illustrating a massage apparatus according to an embodiment.

FIG. 2 is a side view illustrating a massage apparatus according to an embodiment.

FIG. 3 is a side view illustrating a massage apparatus according to an embodiment when a first mode of the massage apparatus is performed.

FIG. 4 is a side view illustrating a massage apparatus according to an embodiment when a second mode of the massage apparatus is performed.

FIG. 5 is a side view illustrating a massage apparatus according to an embodiment when a third mode of the massage apparatus is performed.

FIG. 6 is a control block diagram illustrating a massage apparatus according to an embodiment.

FIG. 7 is a view illustrating a case when a user sits down on a massage apparatus according to an embodiment.

FIG. 8 is a view illustrating a user who is provided with a massage function through a massage apparatus according to an embodiment.

FIG. 9 is a view illustrating a case when a user departs from a massage apparatus according to an embodiment.

FIG. 10 is a flowchart showing a process of assisting in seating of a massage apparatus according to an embodiment.

FIG. 11 is a flowchart illustrating a processing of assisting in exiting of a massage apparatus according to an embodiment.

### DETAILED DESCRIPTION

The embodiments set forth herein and illustrated in the configuration according to the disclosure are only the most preferred embodiments, so it should be understood that they may be replaced with various equivalents and modifications at the time according to the disclosure.

Throughout the drawings, like reference numerals refer to like parts or components.

The terminology used herein is for the purpose of describing particular embodiments only and is not intended to restrict and/or limit the disclosure. It is to be understood that the singular forms “a,” “an,” and “the” include plural references unless the context clearly dictates otherwise. It will be further understood that the terms “include”, “comprise” and/or “have” when used in this specification, specify the presence of stated features, integers, steps, operations, elements, and/or components, but do not preclude the presence or addition of one or more other features, integers, steps, operations, elements, components, and/or groups thereof.

The terms including ordinal numbers like “first” and “second” may be used to explain various components, but the components are not limited by the terms. The terms are only for the purpose of distinguishing a component from another. Thus, a first element, component, region, layer or section discussed below could be termed a second element, component, region, layer or section without departing from the teachings according to the disclosure. Descriptions shall be understood as to include any and all combinations of one or more of the associated listed items when the items are described by using the conjunctive term “˜and/or˜,” or the like.

Hereinafter, embodiments according to the disclosure will be described in detail with reference to the accompanying drawings.

One aspect of the disclosure provides a massage apparatus having an improved structure to assist a user with entering or exiting the massage apparatus.

As is apparent from the above, the angle of a seat frame with respect to a base frame is provided to be changeable, so that a user's movement may be assisted when the user sits down on or stands up from the massage apparatus, thereby increasing convenience of use.

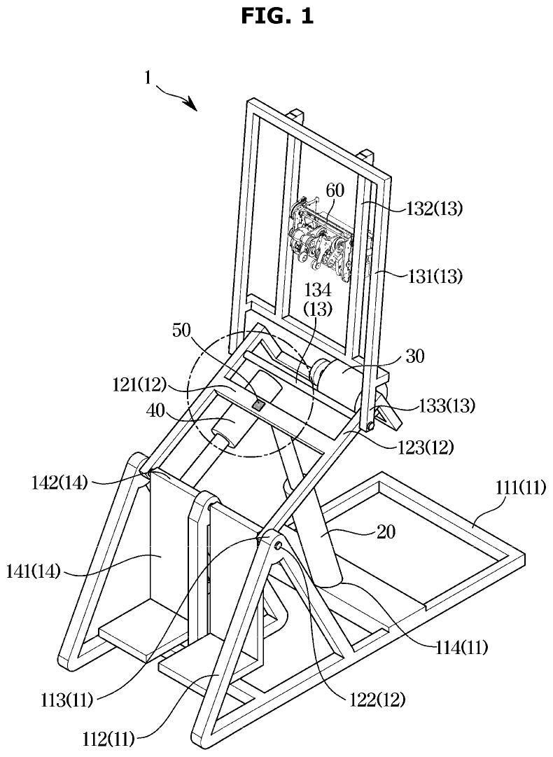

FIG. 1 is a perspective view illustrating a massage apparatus according to an embodiment.

Referring to FIG. 1, a massage apparatus 1 is an apparatus that provides a user with a massage. The massage apparatus 1 may be implemented in the form of a chair in which a user may take a rest while being seated or lying down.

The massage apparatus 1 may include a base frame 11 and a plurality of seat frames 12 and 13.

The base frame 11 may include a bottom leg 111 and a support leg 112.

The bottom leg 111 may be provided to be supported on an installation surface on which the massage apparatus 1 is installed. The bottom leg 111 may be disposed in parallel with the installation surface to support the load of the massage apparatus 1.

The support leg 112 may be connected to the bottom leg 111 at a front side of the bottom leg 111. The support leg 112 may extend upward from the bottom leg 111.

The support leg 112 may be connected to a first seat frame 12. The support leg 112 may be provided to allow a frame support shaft 122 of the first seat frame 12 to pass therethrough.

The support leg 112 may include a seat rotating portion 113 formed at an upper end of the support leg 112. For example, the frame support shaft 122 of the first seat frame 12 may pass through the seat rotating portion 113 of the support leg 112.

The support leg 112 may form an approximately triangular support body together with the bottom leg 111. However, the shape of the support leg 112 is not limited thereto.

The bottom leg 111 may include a drive coupling portion 114. The driving coupling portion 114 may be formed in the center of the bottom leg 111 and a first driving unit 20 may be mounted on the drive coupling portion 114. For example, a base connection portion 21 of the first driving unit 20 may be mounted on the drive coupling portion 114 of the bottom leg 111.

The plurality of seat frames 12 and 13 may include a first seat frame 12 and a second seat frame 13.

The first seat frame 12 and the second seat frame 13 may extend while being coupled to each other along the front-back direction to support from the user's head to the upper body, buttocks, and parts of the lower body. However, the shape of the plurality of seat frames 12 and 13 may not be limited to the shape shown in FIG. 1.

The first seat frame 12 and the second seat frame 13 may support the user in a sitting state or lying state while in contact with the rear surface of the user's body.

The first seat frame 12 may be coupled to the base frame 11 to form a seating portion 121 at one side thereof. For example, a front surface of the first seat frame 12 may form the seating portion 121 on which a part of the user's body is seated.

The first seat frame 12 may be rotatably coupled to the base frame 11. The first seat frame 12 may be coupled to the seat rotation portion 113 of the base frame 11 such that the buttocks of the user's body are seated and supported thereon.

The first seat frame 12 may include the frame support shaft 122 extending sideward of the first seat frame 12 and passing through the base frame 11. The first seat frame 12 may be rotatable with respect to the base frame 11 around the frame support shaft 122.

In addition, the frame support shaft 122 of the first seat frame 12 may pass through a leg frame 14 to be described below such that the angle between the leg frame 14 and the first seat frame 12 may be adjusted.

The first seat frame 12 may include a backrest connection portion 123. A backrest rotation shaft 134 of the second seat frame 13 may be coupled to the backrest connection portion 123 of the first seat frame 12. With such a configuration, the angle between the first seat frame 12 and the second seat frame 13 may be adjusted.

The second seat frame 13 may be coupled to the first seat frame 12 to form a backrest portion 131 at one side thereof. For example, a front surface of the second seat frame 13 may form the backrest portion 131 on which a part of the user's body is seated.

For example, the second seat frame 13 may be coupled to be rotatably with respect to the first seat frame 12. The second seat frame 13 may be rotatably coupled to the backrest connection portion 123 of the first seat frame 12 such that the back and head of the user's body may be seated and supported thereon.

The second seat frame 13 may include a module support portion 132. A massage module 60 may be mounted on the module support portion 132. The massage module 60 may move in the up and down direction along the module support portion 132. The massage module 60 may be separately controlled to perform a massage on the rear surface of the user's body.

The second seat frame 13 may include a frame coupling portion 133 and a backrest rotation shaft 134.

The frame coupling portion 133 may be provided to be coupled to the first seat frame 12. For example, the backrest rotation shaft 134 may pass through the frame coupling portion 133 of the second seat frame 13 such that the second seat frame 13 may be coupled to be rotatable with respect to the first seat frame 12.

The backrest rotation shaft 134 of the second seat frame 13 may pass through the backrest connection portion 123 of the first seat frame 12.

The backrest rotation shaft 134 may be provided in a bar-shaped structure that extends along the left-right direction of the massage apparatus 1. However, the shape of the backrest rotation shaft 134 is not limited thereto.

The seat portion 121 of the first seat frame 12 and the backrest portion 131 of the second seat frame 13 may be provided as a type of seating surface that may be in contact with the user's body. In FIG. 1, a separate exterior cover is omitted, but the massage apparatus 1 according to an embodiment of the disclosure may include a cushiony material, which may be provided to surround the first seat frame 12 and the second seat frame 13.

The massage apparatus 1 may include the leg frame 14.

The leg frame 14 may include a footrest portion 141 on which a part of the user's body is seated. The footrest portion 141 may be formed on a front surface of the leg frame 14 such that the leg part of the user's body is seated thereon.

The leg frame 14 may include a seat coupling portion 142. The leg frame 14 may be coupled to be rotatable with respect to the first seat frame 12. For example, the frame support shaft 122 of the first seat frame 12 may be provided to pass through the seat coupling portion 142 of the leg frame 14. With such a configuration, the angle between the leg frame 14 and the first seat frame 12 may be adjusted.

The massage apparatus 1 may include a first driving unit 20, a second driving unit 30 and a third driving unit 40.

The first driving unit 20 may provide the first seat frame 12 with driving force such that the angle formed by the first seat frame 12 and the base frame 11 changes. For example, the first driving unit 20 may be connected to the base frame 11 and the first seat frame 12. For example, the first driving unit 20 may be mounted on the drive coupling portion 114 formed on the bottom leg 111 of the base frame 11.

The first driving unit 20 may include a base connection portion 21 and a seat connection portion 22.

The seat connection portion 22 may be slidably moved with respect to the base connection portion 21. The seat connection portion 22 may be connected to the lower surface of the first seat frame 12 such that the first seat frame 12 rotates with respect to the base frame 11 about the frame support shaft 122.

The first driving unit 20 may be provided as an electromagnetic motor. However, a driving method of the first driving unit 20 is not limited thereto.

For example, the seat connection portion 22 may be provided to be movable in a direction away from the base connection portion 21 or in a direction closer to the base connection portion 21. The seat connection portion 22 may press the lower surface of the first seat frame 12 to adjust the angle between the first seat frame 12 and the base frame 11.

The second driving unit 30 may be disposed between the first seat frame 12 and the second seat frame 13. The second driving unit 30 may provide the second seat frame 13 with driving force. The second driving unit 30 may be provided to adjust the angle between the first seat frame 12 and the second seat frame 13.

According to the disclosure, the second driving unit 30 may be disposed between the first seat frame 12 and the second seat frame 13, thereby increasing the spatial efficiency of the upper part of the base frame 11.

The third driving unit 40 may provide the leg frame 14 with driving force. The third driving unit 40 may be coupled to the leg frame 14 below the first seat frame 12.

The third driving unit 40 may be provided to press the rear surface of the leg frame 14. The third driving unit 40 may include an electromagnetic motor provided to change in length. As the third driving unit 40 presses the leg frame 14, the angle between the first seat frame 12 and the leg frame 14 may be adjusted.

The massage apparatus 1 may include a sensor 50.

The sensor 50 may be provided as a weight sensor 50 or a distance sensor 50. The sensor 50 may detect whether the user is in a seating position or in a standing position on the first seat frame 12.

Although not shown, the massage apparatus 1 according to an embodiment of the disclosure may include a housing for covering the base frame 11 and the plurality of seat frames 12 and 13. The housing may be provided to cover all of the upper, lower, left, and right sides of the user when the user is seated on the seat frame. The housing may include armrest portions on which the user's arms are seated.

However, it is not limited thereto, and the housing may be provided in various shapes to form the external appearance of the massage apparatus 1 and improve the overall aesthetics of the massage apparatus 1.

In addition, the housing may be provided to cover at least a portion of the upper, lower, left, and right sides of the user such that the user using the massage apparatus 1 feels isolated from the external environment.

In addition, a manipulation unit 70 to which a user command is input may be formed on one surface of the housing. For example, the manipulation unit 70 [symbol] an input unit to which a user command is input. A user may input a command to the massage apparatus 1 through the manipulation unit 70, and the command input through the manipulation unit 70 may be transmitted to a control unit of the massage apparatus 1 such that various massage modes may be performed.

However, the input method of the manipulation unit 70 is not limited thereto, and a user command may be input to the control unit through remote control using a wireless communication method.

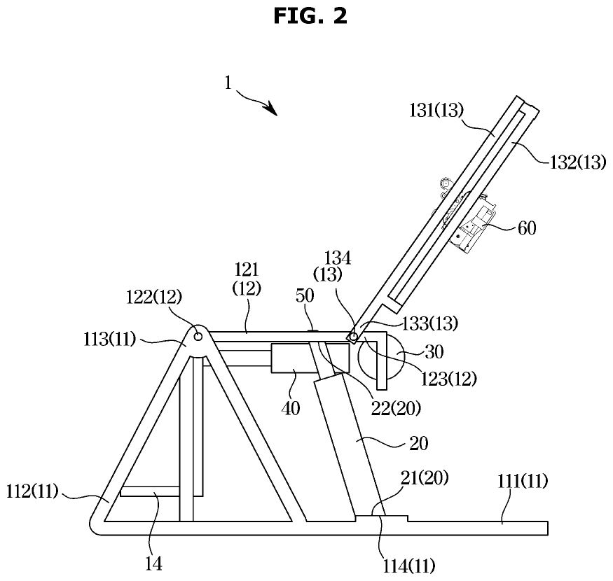

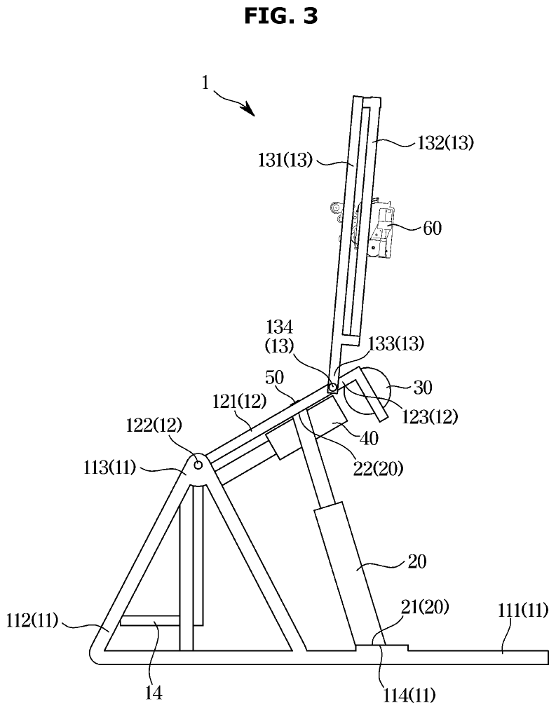

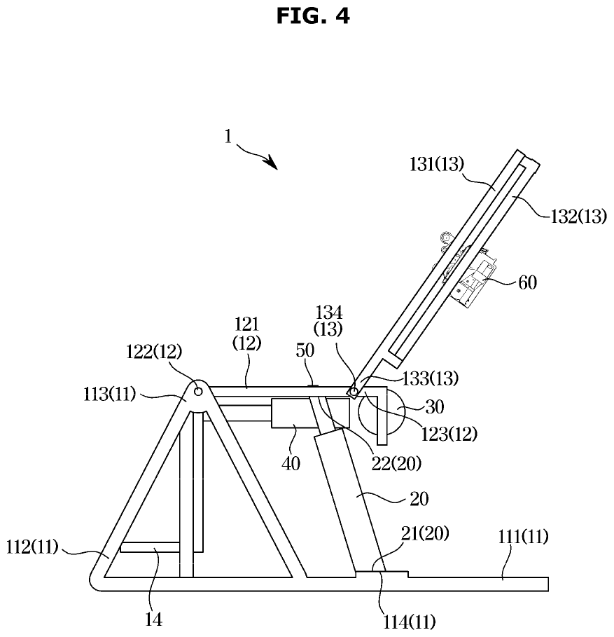

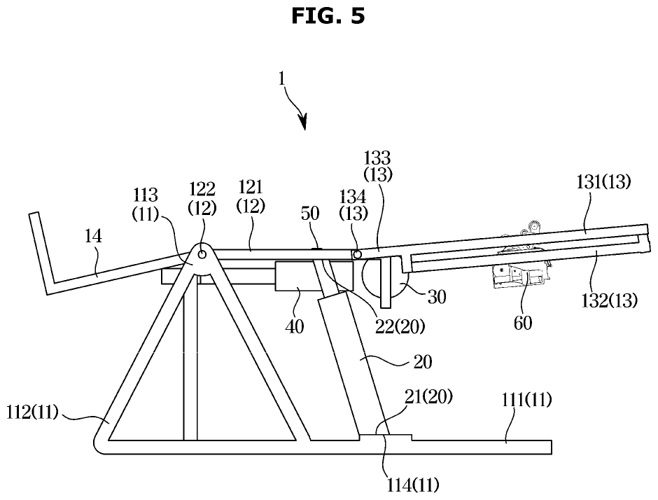

FIG. 2 is a side view illustrating a massage apparatus according to an embodiment. FIG. 3 is a side view illustrating a massage apparatus according to an embodiment when the first mode of the massage apparatus is performed. FIG. 4 is a side view illustrating a massage apparatus according to an embodiment when the second mode of the massage apparatus is performed. FIG. 5 is a side view illustrating a massage apparatus according to an embodiment when the third mode of the massage apparatus is performed.

Referring to FIGS. 2 to 5, the first mode, the second mode, and the third mode of the massage apparatus 1 according to the disclosure will be described.

Referring to FIG. 2, the massage apparatus 1 according to an embodiment of the present disclosure may stand by in a state shown in FIG. 2 when the user does not use the massage apparatus 1.

Then, referring to FIG. 3, the massage apparatus 1 may perform the first mode by rotating the first seat frame 12 in a direction away from the base frame 11. For example, when the first mode is performed, the massage apparatus 1 may be driven to change from a state shown in FIG. 2 to a state shown in FIG. 3.

The first mode may be referred to as a seating assistance mode or an exit assistance mode.

When a start signal of a massage cycle is received by the control unit, the first seat frame 12 of the massage apparatus 1 may be rotated with respect to the base frame 11 so as to be inclined with respect to the base frame 11.

For example, in the first mode, the first seat frame 12 of the massage apparatus 1 may rotate with respect to the base frame 11 such that the rear side of the seating portion 121 is located at a higher position than the front side of the seating portion 121.

In the first mode, the seat connection portion 22 of the first driving unit 20 may move away from the base connection portion 21. For example, the seat connection portion 22 of the first driving unit 20 may be slidably moved from the base connection portion 21 toward the first seat frame 12.

The seat connection portion 22 may press the lower surface of the first seat frame 12. Based on the movement of the seat connection portion 22, the first seat frame 12 may be rotated forward with respect to the base frame 11. For example, the first seat frame 12 may be rotated counterclockwise relative to the base frame 11 about the frame support shaft 122.

As the first seat frame 12 is inclined toward the front, which is a side that the user may approaches, the user may more easily sit down on the massage apparatus 1.

In addition, when a signal for ending the massage cycle is received by the control unit, the first seat frame 12 of the massage apparatus 1 may be rotated with respect to the base frame 11 in a state shown in FIG. 4 or FIG. 5 so as to be inclined with respect to the base frame 11.

In this case, the first seat frame 12 of the massage apparatus 1 may operate in the same manner as when assisting the user with sitting.

However, when an exit of the user is detected by the sensor 50, the first seat frame 12 may stop rotating forward, and rotate again backward. This is to prevent redundant driving when the user has exited the massage apparatus 1, since there is no need for further operation assistance.

Referring to FIG. 4, the massage apparatus 1 may perform the second mode by rotating the first seat frame 12 in a direction closer to the base frame 11. For example, when the second mode is performed, the massage apparatus may be driven to change from a state shown in FIG. 3 to a state shown in FIG. 4.

The second mode may be referred to as a standby mode or a massage mode.

When a seating of the user is detected by the sensor 50 of the first seat frame 12, the first seat frame 12 may be rotated with respect to the base frame 11 so as to be disposed in parallel to the base frame 11.

For example, in the second mode, the first seat frame 12 of the massage apparatus 1 may be rotated with respect to the base frame 11 such that the front side of the seating portion 121 and the rear side of the seating portion 121 are located at the same height.

In the second mode, the seat connection portion 22 of the first driving unit 20 may move closer to the base connection portion 21. For example, the seat connection portion 22 of the first driving unit 20 may be slidably moved toward the base connection portion 21.

The lower surface of the first seat frame 12 connected to the seat connection portion 22 may be moved based on the movement of the seat connection portion 22. For example, the first seat frame 12 may be rotated backward with respect to the base frame 11 based on the movement of the seat connection portion 22. For example, the first seat frame 12 may be rotated clockwise with respect to the base frame 11 about the frame support shaft 122.

The second mode may be a standby mode in which the user waits before receiving a massage. However, it is not limited thereto, and the second mode may be provided as a massage mode in which the user may receive a massage while being seated.

Referring to FIG. 5, the massage apparatus 1 may perform the third mode by rotating the second seat frame 13 and the leg frame 14. For example, when the third mode is performed, the massage apparatus may be driven to change from a state shown in FIG. 4 to a state shown in FIG. 5.

The third mode may be referred to as a reclining mode.

For example, in the third mode, the leg frame 14 of the massage apparatus 1 may rotate forward with respect to the first seat frame 12. In addition, in the third mode, the second seat frame 13 of the massage apparatus 1 may rotate backward with respect to the first seat frame 12.

In the third mode, the second driving unit 30 may drive the second seat frame 13. Based on the driving of the second driving unit 30, the second seat frame 13 may rotate in a direction away from the first seat frame 12.

The third driving unit 40 may drive the leg frame 14. Based on the driving of the third driving unit 40, the leg frame 14 may rotate in a direction away from the first seat frame 12. For example, as the length of the third driving unit 40 increases, the third driving unit 40 may press the rear surface of the leg frame 14.

In the third mode, the leg frame 14, the first seat frame 12, and the second seat frame 13 may be disposed substantially in parallel with each other. In the third mode, the massage apparatus 1 may support the user in a lying state.

In such a reclining mode, the user may receive a massage by selecting an appropriate massage mode. Alternatively, the reclining mode may be performed for the user to take a rest without receiving 00a separate massage.

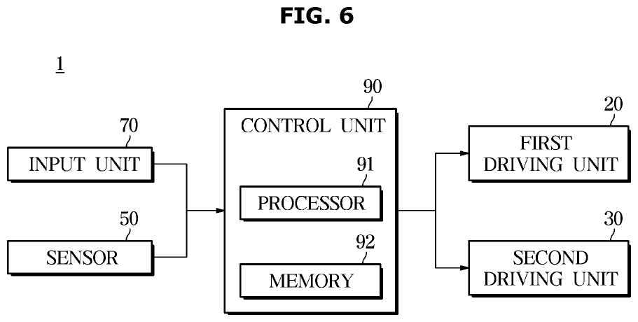

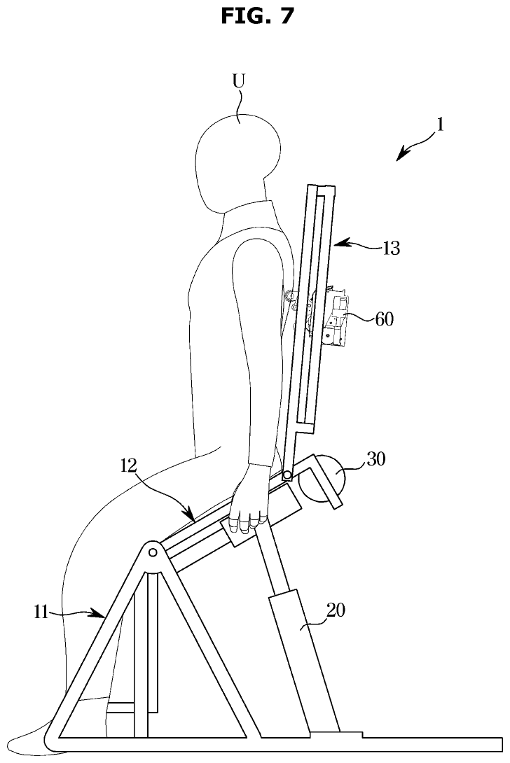

FIG. 6 is a control block diagram illustrating a massage apparatus according to an embodiment. FIG. 7 is a view illustrating a case when a user sits down on a massage apparatus according to an embodiment.

The massage apparatus 1 may include the base frame 11, the first seat frame 12, the second seat frame 13, the first driving unit 20, the second driving unit 30, and the massage module 60, which are described above, and further include a control unit 90 for controlling the first driving unit 20, the second driving unit 30, and the massage module 60. In addition, the control unit 90 may include at least one processor 91 and a memory 92.

The control unit 90 may include the memory 92, in which a control program and control data for controlling the first driving unit 20, the second driving unit 30, and the massage module 60 based on ending and execution commands for massage courses or a result of detection of the sensor 50 are stored, and the at least one processor 91 that generates a control signal according to the control program and the control data stored in the memory 92. The memory 92 and the processor 91 may be provided as one part or separate parts.

The memory 92 may store at least detection information of the sensor 50 and may store programs and data for controlling the first driving unit 20, the second driving unit 30, and the massage module 60.

The memory 92 may include a volatile memory for temporarily storing data, such as a static random access memory (S-RAM), a dynamic random access memory (D-RAM), and the like. In addition, the memory 92 may include a non-volatile memory for storing data for a long period of time, such as a read only memory (ROM), an erasable programmable read only memory (EPROM), an electrically erasable programmable ROM (EEPROM), and the like.

The at least one processor 91 may include various logic circuits and arithmetic circuits, process data according to a program provided from the memory 92, and generate a control signal according to a processing result.

The control unit 90 may determine whether an execution command for a massage course is input.

The control unit 90 may, upon determining that the execution command for the massage course is input, control the first driving unit to rotate the first seat frame 12 such that the rear side of the first seat frame 12 is raised.

That is, the control unit 90 may control the first driving unit 20 to rotate the first seat frame 12 in a direction away from the base frame 11 to perform the first mode (a seating assistance mode) described above.

Accordingly, the massage apparatus may be set into a form in which the user may easily sit down on the massage apparatus 1 as shown in FIG. 7.

The control unit 90 may, in response to the first seat frame 12 being rotated to perform the first mode (a seating assistance mode), control the second driving unit 30 to rotate the second seat frame 13.

Specifically, when the first seat frame 12 and the second seat frame 13 maintain a constant angle therebetween, the raising of the rear side of the first seat frame 12 according to the rotation of the first seat frame 12 may cause an upper end of the second seat frame 13 including the backrest portion 131 to be tilted forward, which leads to inconvenience when the user sits down on the massage apparatus 1.

Accordingly, in order to prevent the upper end of the backrest portion 131 from being excessively tilted forward, the control unit 90 may control the second driving unit for the second seat frame 13 to maintain a reference angle from the ground according to the rotation of the first seat frame 12.

In this case, the reference angle may be set to an appropriate angle that does not cause inconvenience to the user when the user sits down on the massage apparatus 1.

As the second seat frame 13 is maintained at a constant angle from the ground, the upper end of the second seat frame 13 may be prevented from tilting forward even when the first seat frame 12 rotates, so that the user may easily sit down on the massage apparatus 1.

After the user sits down on the massage apparatus 1, there is a need to lower the raised first seat frame 12 again to execute a massage function, which will be described below.

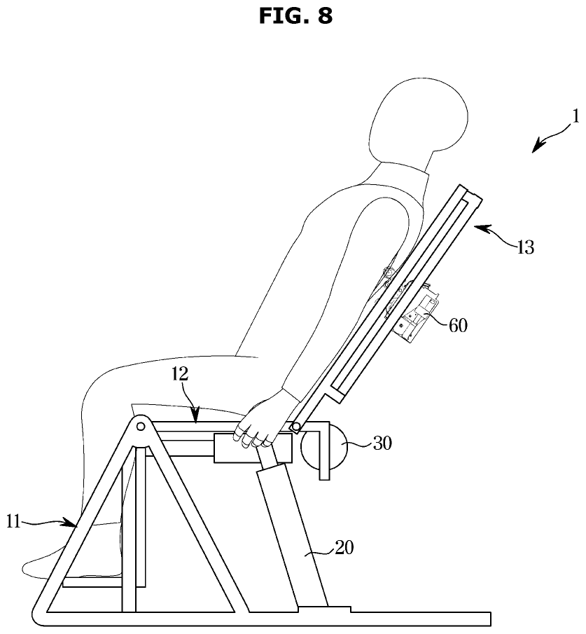

FIG. 8 is a view illustrating a user who is provided with a massage function through a massage apparatus according to an embodiment.

The massage apparatus 1 may further include a sensor 50 as described above to determine whether the user is seated on or departed from the massage apparatus 1.

The sensor 50 may be accommodated in the first seat frame 12, but the disclosure is not limited thereto and may be provided in various positions as long as it can detect whether a user is seated on or departed from the massage apparatus. In the disclosure, the sensor 50 is illustrated as being provided in the first seat frame 12.

Upon determining that the user is seated on the massage apparatus 1 based on a detection result of the sensor 50, the control unit 90 may control the first driving unit to rotate the first seat frame 12 such that the rear side of the first seat frame 12 is lowered.

That is, the first seat frame 12 may be rotated in a direction closer to the base frame 11 to perform the second mode (a massage mode) for executing a massage course.

The control unit 90 may, in response that the rear side of the first seat frame 12 is lowered according to the rotation of the first seat frame 12 and thus located at the same height as that of the front side of the seating portion 121, control the massage module 60 to provide the user with a massage function.

Hereinafter, a process in which the user departs from the massage apparatus 1 after the ending of the massage course will be described.

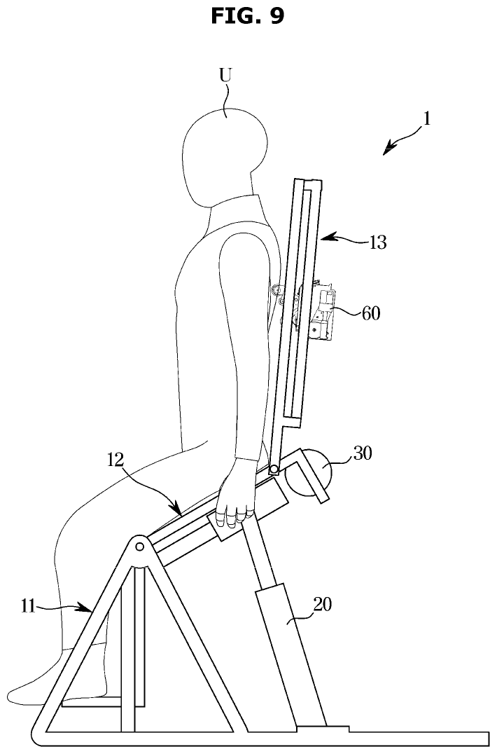

FIG. 9 is a view illustrating a case when a user who departs a massage apparatus according to an embodiment.

The control unit 90 may, upon a predetermined operation of the massage course being completed, or upon an end command for the massage course being received from the user through a separate input, control the first driving unit to rotate the first seat frame 12 such that the rear side of the first seat frame is raised.

That is, the control unit may control the first driving unit 20 to rotate the first seat frame 12 in a direction away from the base frame 11 to perform the first mode (an exit assistance mode) described above.

Referring to FIG. 9, as the rear side of the seating portion 121 is raised according to raising of the rear side of the first seat frame 12, the massage apparatus 1 may be set into a form in which the user seated on the seating portion 121 easily departs from the massage apparatus 1.

The control unit 90 may, in response to the first seat frame 12 being rotated to perform the first mode, control the second driving unit 30 to rotate the second seat frame 13.

Specifically, when the first seat frame 12 and the second seat frame 13 maintain a constant angle therebetween, the raising of the rear side of the first seat frame 12 according to the rotation of the first seat frame 12 may cause an upper end of the second seat frame 13 including the backrest portion 131 to be tilted forward, which leads to inconvenience when the user departs from the massage apparatus 1.

Accordingly, in order to prevent the upper end of the backrest portion 131 from being excessively tilted forward, the control unit 90 may control the second driving unit for the second seat frame 13 to maintain a reference angle from the ground according to the rotation of the first seat frame 12.

In this case, the reference angle may be set to an appropriate angle that does not cause inconvenience to the user when the user departs from the massage apparatus 1.

The control unit 90 may, upon determining that the user has departed from the massage apparatus 1 based on a detection result of the sensor 50, control the first driving unit to rotate the first seat frame 12 such that the rear side of the first seat frame 12 is lowered.

That is, the control unit may, in order to perform the second mode (a standby mode), rotate the first seat frame 12 in a direction closer to the base frame 11.

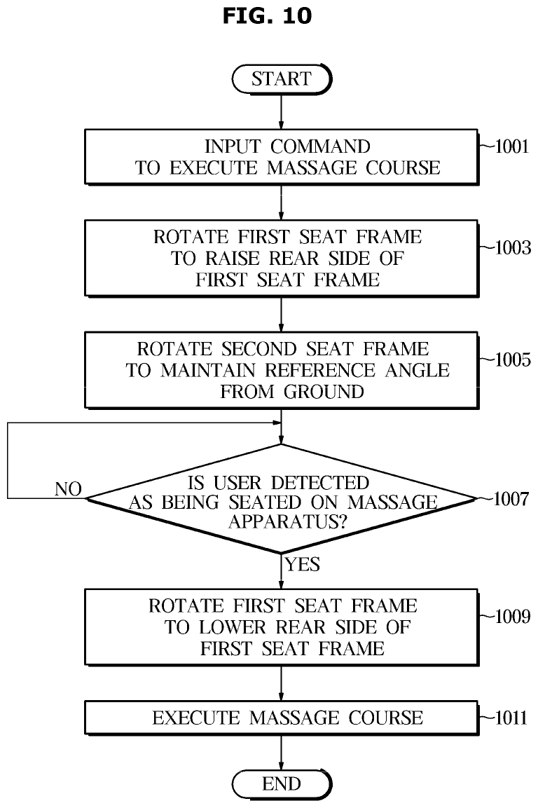

FIG. 10 is a flowchart showing a process of assisting in seating of a massage apparatus according to an embodiment.

The control unit may, upon an execution command for a massage course being input (1001), control the first driving unit to rotate the first seat frame 12 such that the rear side of the first seat frame 12 is raised (1003).

That is, the control unit may control the first driving unit 20 to rotate the first seat frame 12 in a direction away from the base frame 11 to perform the first mode (a seating assistance mode) described above.

The control unit 90 may, in response to the first seat frame 12 being rotated to perform the first mode (a seating assistance mode), control the second driving unit 30 to rotate the second seat frame 13.

Specifically, when the first seat frame 12 and the second seat frame 13 maintain a constant angle therebetween, the raising of the rear side of the first seat frame 12 according to the rotation of the first seat frame 12 may cause an upper end of the second seat frame 13 including the backrest portion 131 to be tilted forward, which leads to inconvenience when the user sits down on the massage apparatus 1.

Accordingly, in order to prevent the upper end of the backrest portion 131 from being excessively tilted forward, the control unit 90 may control the second driving unit for the second seat frame 13 to maintain a reference angle from the ground according to the rotation of the first seat frame 12 (1005).

The control unit 90 may determine whether the user is seated on the massage apparatus 1 based on the detection result of the sensor 50 (1007).

The control unit may, upon determining that the user is seated on the massage apparatus 1 based on the detection result of the sensor 50 (YES in operation 1007), control the first driving unit to rotate the first seat frame 12 such that the rear side of the first seat frame 12 is lowered (1009).

The control unit 90 may, in response that the rear side of the first seat frame 12 is lowered according to the rotation of the first seat frame 12 and thus located at the same height as that of the front side of the seating portion 121, control the massage module 60 to provide the user with a massage function (1011).

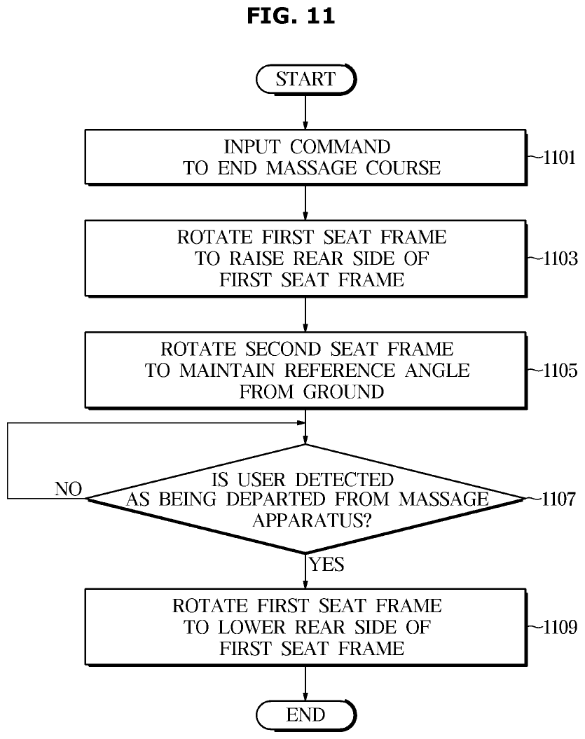

FIG. 11 is a flowchart illustrating a process of assisting in exiting of a massage apparatus according to an embodiment.

The control unit 90 may, upon a predetermined operation of the massage course being completed or upon an end command for the massage course being received from the user through a separate input (1101), control the first driving unit to rotate the first seat frame 12 such that the rear side of the first seat frame is raised (1103).

That is, the control unit 90 may control the first driving unit 20 to rotate the first seat frame 12 in a direction away from the base frame 11 to perform the first mode (an exit assistance mode) described above.

The control unit 90 may, in response to the first seat frame 12 being rotated to perform the first mode, control the second driving unit 30 to rotate the second seat frame 13.

Specifically, when the first seat frame 12 and the second seat frame 13 maintain a constant angle therebetween, the raising of the rear side of the first seat frame 12 according to the rotation of the first seat frame 12 may cause an upper end of the second seat frame 13 including the backrest portion 131 to be tilted forward, which leads to inconvenience when the user departs from the massage apparatus 1.

Accordingly, in order to prevent the upper end of the backrest portion 131 from being excessively tilted forward, the control unit 90 may control the second driving unit for the second seat frame 13 to maintain a reference angle from the ground according to the rotation of the first seat frame 12 (1105).

The control unit 90 may determine whether the user has departed from the massage apparatus 1 based on the detection result of the sensor 50 (1107).

The control unit 90 may, upon determining that the user has departed from the massage apparatus 1 based on a detection result of the sensor 50 (YES in operation 1107), control the first driving unit to rotate the first seat frame 12 such that the rear side of the first seat frame 12 is lowered (1109).

That is, the control unit may rotate the first seat frame 12 in a direction closer to the base frame 11 to perform the second mode (a standby mode).

According to the disclosure, the user may be assisted in moving when the user sits down on the massage apparatus or when the user stands up from the massage apparatus, thereby increasing convenience of use.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

Although embodiments of the disclosure have been described for illustrative purposes, those skilled in the art will appreciate that various modifications, additions and substitutions are possible, without departing from the scope and spirit of the disclosure. Therefore, embodiments of the disclosure have not been described for limiting purposes.

What is claimed is:

1. A massage apparatus comprising:
a base frame;
a first seat frame connected to the base frame to be rotatable with respect to the base frame, the first seat frame including a seat portion on which a user is to be seated;
a second seat frame coupled to the first seat frame to be rotatable with respect to the first seat frame, the second seat frame including a backrest portion on which the user's back is to be rested;
a first driving unit connected to the base frame and the first seat frame to drive the first seat frame to rotate with respect to the base frame;
a massage module accommodated in the second seat frame to perform a massage function; and
a control unit configured to, upon an execution command for a massage course being input, control the first driving unit to rotate the first seat frame so that a rear side of the first seat frame is raised thereby raising the seat portion.

2. [symbol] The massage apparatus of claim 1, further comprising a second driving unit connected to the first seat frame and the second seat frame to drive the second seat frame to rotate with respect to the first seat frame so that the second seat frame maintains a reference angle with respect to a ground according to a rotation of the first seat frame.

3. The massage apparatus of claim 2, further comprising a sensor configured to detect a user,
wherein the control unit is configured to, upon determining that the user is seated on the massage apparatus based on a detection by the sensor, control the first driving unit to rotate the first seat frame so that the rear side of the first seat frame is lowered.

4. The massage apparatus of claim 3, wherein the control unit is configured to, after controlling to lower the rear side of the first seat frame, control the massage module to perform the massage function.

5. The massage apparatus of claim 4, wherein the control unit is configured to, upon receiving a command to end the massage course, controlling the first driving unit to rotate the first seat frame so that the rear side of the first seat frame is raised.

6. The massage apparatus of claim 5, wherein the control unit is configured to control the second driving unit to drive the second seat frame so that the second seat frame maintains the reference angle with respect to the ground according to the rotation of the first seat frame.

7. The massage apparatus of claim 6, wherein the control unit is configured to, upon determining that the user has departed from the massage apparatus based on a detection by the sensor, control the first driving unit to rotate the first seat frame so that the rear side of the first seat frame is lowered.

8. The massage apparatus of claim 1, wherein the first seat frame further includes a frame support shaft extending sideward of the first seat frame and passing through the base frame so that the first seat frame is coupled to be rotatable with respect to the base frame,
wherein the first driving unit includes:
a base connection portion mounted on the base frame; and
a seat connection portion connected to a lower surface of the first seat frame so that the first seat frame rotates with respect to the base frame around the frame support shaft, the seat connection portion slidably movable with respect to the base connection portion.

9. A method of controlling a massage apparatus, the method comprising:
receiving an execution command for a massage course operation; and
controlling to rotate a first seat frame, which is connected to a base frame to be rotatable with respect to the base frame, so that a rear side of the first seat frame is raised thereby raising a seat portion included in the first seat frame.

10. The method of claim 9, further comprising controlling to rotate a second seat frame, which is coupled to the first seat frame to be rotatable with respect to the first seat frame, to maintain a reference angle with respect to a ground according to the rotation of the first seat frame.

11. The method of claim 10, further comprising:
detecting a user by a sensor; and
upon determining that the user is seated on the massage apparatus based on a result of the detection by the sensor, controlling to rotate the first seat frame so that the rear side of the first seat frame is lowered.

12. The method of claim 11, further comprising controlling a massage module to perform a massage function after the rear side of the first seat frame is lowered.

13. The method of claim 12, further comprising:
receiving a command to end the massage course; and
controlling to rotate the first seat frame so that the rear side of the first seat frame is raised.

14. The method of claim 13, further comprising controlling to rotate the second seat frame to maintain the reference angle with respect to the ground according to the rotation of the first seat frame.

15. The method of claim 14, further comprising, upon determining that the user has departed from the massage apparatus based on a detection by the sensor, controlling to rotate the first seat frame so that the rear side of the first seat frame is lowered.

16. The massage apparatus of claim 1, further comprising a second driving unit connected to the first seat frame and the second seat frame to drive the second seat frame to rotate with respect to the first seat frame so that the second seat frame is raised together with the first seat frame thereby raising the seat portion and the backrest portion together.
